(19) United States
(12) Patent Application Publication
(10) Pub. No.: US 2008/0022495 A1
(43) Pub. Date: Jan. 31, 2008

(54) Rope-lock

(76) Inventor: Robert Adamczak, Moose Lake, MN (US)

Correspondence Address: ROBERT ADAMCZAK, 315 LAKESHORE DRIVE, MOOSE LAKE, MN, 55767, US

(21) Appl. No.: 11/368,222

(22) Filed: Jul. 27, 2006

(51) Int. Cl. F16G 11/00

(52) U.S. Cl. 24/115 R

(57) ABSTRACT

Ropes are secured by tying knots, By passing the end of a rope through the eye bolt of the Rope Lock device and tighten the wing nut to secure the rope eliminates the need to tie a knot Individuals that do not know how to tie a seed knot or has limited use of their hand could still secure a rope using the Rope Lock device.

### CROSS-REFERENCE TO RELATED APPLICATIONS

Not Applicable

### REFERENCES CITED

Referenced by U.S. Patent Documents
739,130 September 1903 Whipple
2,188,937 February 1940 Bertram Paul E.
2,468,907 May 1949 Wilson Robert M; et al.
3,319,306 May 1967 Von Tench Alfied L.
4,706,345 November 1987 Rockenfeller et al.

### JOINT RESEARCH AGREEMENT

Not Applicable

### INCORPORATlON-BY-REFERANCE

Not Applicable

### BACKGROUND OF THE INVENTION

My invention is a clamping device for securing a rope, cable, webbig, and the li.

### Field

Ropes, cable, webbing, and such are used to secure many ypes of ts, hauling loads on trailers and vehicles, securing boats to docks, cloths lines, ECT. With this damping device will allow a person can use just a portion of a long rope, cable, or webbing.

This clVping &Avice will aid those not proficient in ting knots to secure the rope, cable, or webbing.

### SUMMARY OF THE INVENTTON

The inveton is based on the asson that not everybody can tie a secure knot

The invention a clamping device would aid someone to secure a rope with out tying a knot

The simple de and ease of operation of the clamping device makes the secung of a rope possible using little or on effort.

### BEREF DESCRIPTION OF THE DRAWINGS

FIGS. 1, 2, and 3 shows the block and eye boft of the Rope Lock unassembled.

FIG. 4 shows the Rope Lock assembled.

FIG. 5 shows a rope inserted in the eye bolt.

FIG. 6 shows the eyebolt tightened securing the rpe,

### DETAILED DESCRIPTION OF THE INVENTION

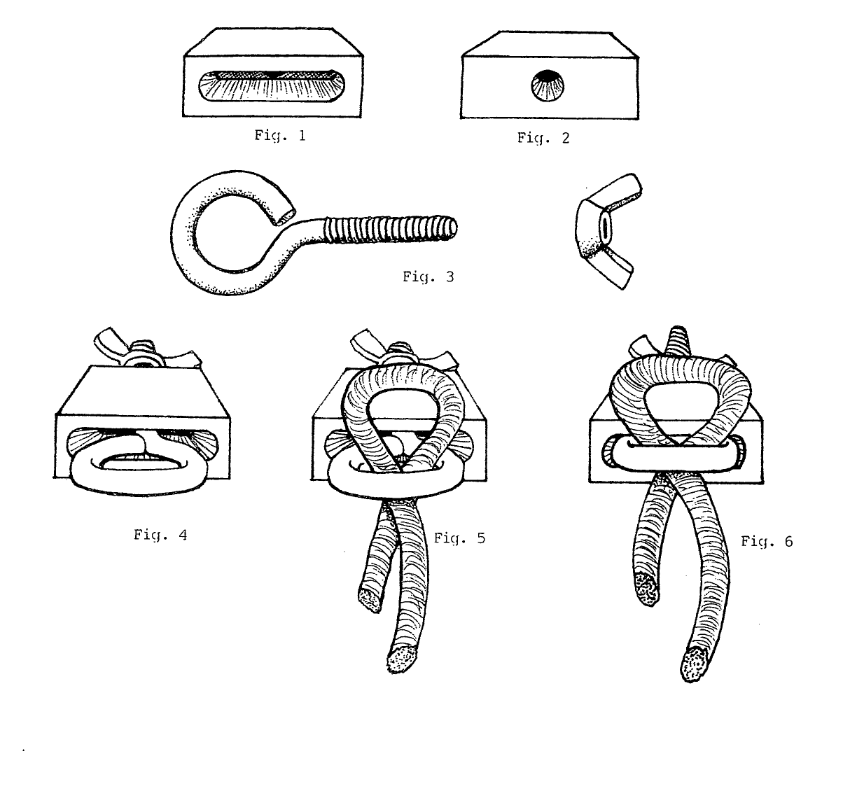

FIG. 1 shows te slot on te top of the block.

FIG. 2 Shows dhe hole on the bottom of the block.

FIG. 3 the ¼″ eye bolt and winut t willhold the rope in place.

FIG. 4 The eye bolt plaed in the slot and te wing nut aached to the eye bolt.

FIG. 5 The rope placed through the eye bolt.

FIG. 6 The wing nut tighten down to hold the rope in place so as not to slip or pull out of the lock block.

1: Rope Lock is a device that when used with a rope eliminates the tying of knots

2: A clamping device for securing a rope comprising:
A rectangular body composed of polymer compound;
A slot on the top edge of said body;
A hole at the bottom of the slot exiting the bottom of the said body;
An eyebolt with the eyelet respectively guided in said slot, shaft of the eyebolt projecting through the bottom of said body;
A wing nut engaged on the end of said eyebolt;
A rope passed through the eye of the eyebolt and the wing nut is tightened compressing the rope between the eyebolt and the body thus securing the rope.

3: The clamping devise defined in claim 1 wherein said polymer compound could be plastic or metal.

4: The clamping devise defined in claim 1 wherein said eyebolt could be J-bolt, L-bolt, or T-bolt.

5: The clamping devise defined in claim I wherein said rope could be light cable or webbing.
